(19) United States
(12) Patent Application Publication
(10) Pub. No.: US 2016/0242506 A1
(43) Pub. Date: Aug. 25, 2016

(54) GLUING-FREE SHOE AND METHOD FOR MANUFACTURING SAME

(71) Applicant: Nam guk KIM, Busan (KR)

(72) Inventor: Nam Guk KIM, Busan (KR)

(21) Appl. No.: 15/025,165

(22) PCT Filed: Sep. 1, 2014
(86) PCT No.: PCT/KR2014/008129

§ 371 Date: Mar. 25, 2016

(30) Foreign Application Priority Data
Sep. 27, 2013 (KR) 10-2013-0115565

(51) Int. Cl. A43B 13/28; B29D 35/12; A43B 13/12; A43B 17/02; A43B 23/02; A43B 7/08

(52) U.S. Cl. CPC A43B 13/28; A43B 23/021; A43B 7/085; A43B 13/12; A43B 17/02; B29D 35/122

(57) ABSTRACT

A gluing-free shoe provides a gluing-free shoe comprising an upper leather and a sole coupled to each other without using glue, wherein the upper leather has an upper leather fixing piece formed on the lower end thereof, a fixing hole extending through the upper leather fixing piece, a reinforcing core material having high strength and durability is embedded on the lower end of the upper leather and inside the fixing piece; the sole comprises a frame, which is fixed to the upper leather, and an outsole fitted to the frame, the frame is injection-molded using a hard synthetic resin or molded using a rubber molding material, a frame fixing piece is formed on the upper side of the periphery of the frame to be positioned outside the upper leather fixing piece formed on the upper leather, a pin coupling hole being formed in the frame fixing piece.

### BACKGROUND

The present invention relates to a gluing-free shoe and a method for manufacturing the same, and in particular to a gluing-free shoe and a method for manufacturing the same wherein an upper leather, an outsole which constitutes a sole, and a frame can be firmly coupled without using any glue, by means of which a working environment can be improved, a shoe productivity can be enhanced, a defective ratio and a labor cost can be reduced, and an air ventilation and a water drainage ability can be enhanced.

A shoe in general consists of a sole disposed beneath an upper leather and adapted to contact with the ground. In case of the upper leather and the sole, they are bonded using a predetermined adhesive. The shoe is manufactured in a sequence consisting of a pre-process (an upper leather is washed, dried and primer-coated), a drying step, an adhesive coating step, a drying step, a bonding step, a compressing step, and a dislocating step.

According to the aforementioned shoe and method for manufacturing the same, since the upper leather and the sole are bonded using a predetermined adhesive, many workers are necessary, which means an increased labor cost. Since a chemical adhesive is inevitably used, a work condition is bad, and a lot of working time is required.

Since a heat drying chamber, a pre-process line, an adhesive line, a compressing device, etc. are essential due to the bonding process, a relatively wide work space is necessary. A bonding defect may occur due to an abnormal process. A power consumption may increase due to an energy consumption during the drying processes.

As a conventional shoe and a method for manufacturing the same, there are the Korean patent laid-open number (A) 10-2004-0039544 (May 12, 2004) entitled “a method for manufacturing shoes, and a shoe manufactured using the method”, and the Korean patent registration number (B1) 10-0310871 (Oct. 17, 2001) entitled “a shoe and a method for manufacturing the same”. According to the aforementioned inventions, the upper leather and the sole are bonded using a predetermined adhesive.

### PRIOR ART DOCUMENTS

Korean Patent Laid-open No. KR 1020040039544 A May 12, 2004
Korean Patent Registration No. KR 100310871 B1 Oct. 17, 2001

### SUMMARY OF THE INVENTION

The present invention has been made in an effort to solve the above-described problems associated with prior art.

It is an object of the present invention to provide a gluing-free shoe and a method for manufacturing the same wherein an upper leather, an outsole which constitutes a sole, and a frame can be firmly coupled without using any glue, by means of which a working environment can be improved, a shoe productivity can be enhanced, a defect ratio and a labor cost can be reduced, and an air ventilation and a water drainage ability can be enhanced.

To achieve the above object, in a gluing-free shoe wherein a sole is coupled to an upper leather without using any adhesive, there is provided a gluing-free shoe, which may include, but is not limited to, an upper leather; and a sole, wherein the upper leather and the sole are coupled by a plurality of frame fixing pieces of the sole and a plurality of fixing pins which are inserted into a plurality of pin engaging holes and a plurality of fixing holes formed at the upper leather, thus coupling the upper leather and the sole without using any adhesive, wherein the upper leather includes a plurality of upper leather fixing pieces which are formed protruding from the lower ends of the upper leather, with a fixing hole formed passing through each upper leather fixing piece, and a reinforcing core with a high strength and durability is embedded at the lower ends of the upper leather and inside the upper leather fixing pieces, and the sole includes a frame fixed at the upper leather, and an outsole inserted into the frame, and the frame is injection-molded using a synthetic resin or is made of a rubber mold material formed using a rubber material, and the sole includes a plurality of frame fixing pieces which are formed upward at the edges thereof, and a pin engaging hole is formed at each frame fixing piece, and the frame fixing pieces are disposed outside the upper leather fixing pieces formed at the upper leather, and the outsole includes an upper plate which is seated on the top of the frame and is made of a hard synthetic resin, and a foam-molded lug which is integral with the upper plate so as to be inserted into an outsole assembling hole while passing through the frame from top to bottom or the outsole is provided in an integrally molded sole structure wherein the upper plate and the lug are integrated using any of a synthetic resin, an EVA sponge, a PU and a tuber, and a head formed larger than the pin engaging hole is formed at a rear end of the fixing pin, and a hook is formed at a front end, wherein the hook is hooked by an engaging groove formed at the upper plate of the outsole.

The lasting process is carried out in such a way that a synthetic fiber thread is bound in a zigzag shape via a fixing hole of each upper leather fixing piece formed at the upper leather, and the fixing pin is hooked by the fixing hole formed at each upper leather fixing piece and by the pin engaging hole formed at each frame fixing piece by forming a protrusion engaging part in front of the head.

Moreover, the upper leather and the portions of the toe and of the heel of the frame are coupled by a sewing method.

In a gluing-free shoe wherein a sole is coupled to an upper leather without using any adhesive, there is provided a method for manufacturing a gluing-free shoe which is formed of an upper leather; and a sole, wherein the upper leather and the sole are coupled by a plurality of frame fixing pieces of the sole and a plurality of fixing pins which are inserted into a plurality of pin engaging holes and a plurality of fixing holes formed at the upper leather, thus coupling the upper leather and the sole without using any adhesive, which may include, but is not limited to, a step wherein an upper leather is covered over a shoe last; a step wherein a rug is inserted into an outsole assembling hole of a frame which is injection-molded with a synthetic resin or is made of a rubber material molded with a rubber material, wherein the rug is formed at any of an outsole including an upper plate which is made of a hard synthetic resin and is seated on the top of the frame, and a lug which is foam-molded integral with the upper plate so as to be inserted into the outsole assembling holes formed passing through the frame or an outsole which is constituted in a structure wherein the upper plate and the lug are constituted in an integrated and molded sole type using any of a synthetic resin, an EVA sponge, a PU and a rubber; a step wherein in a state where the frame fixing pieces formed at the top of the frame are disposed outside the upper leather fixing pieces formed at the lower ends of the upper leather, the fixing pin is coupled in such a way that the hook at the front end thereof is hooked by the engaging groove formed at the upper plate of the outsole in a state where the fixing pin has been inserted in the fixing hole of the upper leather via a pin engaging hole formed at each frame fixing piece; and a step wherein the upper leather is separated from the shoe last, wherein the aforementioned steps are carried out in the sequence where they appear.

Moreover, the lasting process is carried out, wherein the synthetic fiber thread is connected in a zigzag shape to the fixing hole of each upper leather fixing piece formed at the upper leather after the upper leather is covered over the shoe last.

Furthermore, the portions of the toe and of the heel of the frame are coupled with the upper leather by a sewing method based on the function of the shoe, whereby a more complete engagement of the upper leather and the outsole can be obtained.

The gluing-free show and method for manufacturing the same according to the present invention are able to provide the following advantageous effects.

A bond adhering process can be eliminated when coupling the upper leather and the sole, by means of which about ⅖ of the workers for a shoe manufacturing line can be reduced, thus saving a lot of labor costs.

Since a chemical adhesive is not used, an eco-friendly shoe manufacturing environment can be made, and a comfort working environment can be made.

The working time can be greatly reduced.

Since the heat drying chamber, the pre-process line, the adhesive line, the compressing device, etc., which are used for the sake of the adhering process, are not necessary, the work space can be greatly reduced.

Any defect does not exist in terms of the bonding process.

Since any energy consumption does not occur in relation with the drying process, etc., electric power consumption can be reduced.

Since a natural water drainage and an air ventilation effect can be obtained between the upper leather and the sole, the present invention can be well applied to an outdoor product.

Moreover, since a user is able to use a foamed material, which can be customized, as an exchangeable insole, the functionality and selectivity of the shoe can be enhanced.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a front view illustrating a gluing-free shoe according to the present invention;

FIG. 2 is a cross sectional view in FIG. 1;

FIG. 3 is a disassembled perspective view illustrating a gluing-free shoe according to the present invention;

FIG. 4 is an enlarged cross sectional view illustrating a heel portion of a gluing-free shoe according to the present invention; and

FIG. 5 is a block diagram for describing a method for manufacturing a gluing-free shoe according to the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

The gluing-free shoe and method for manufacturing the same according to the present invention will be described with reference to the accompanying drawings.

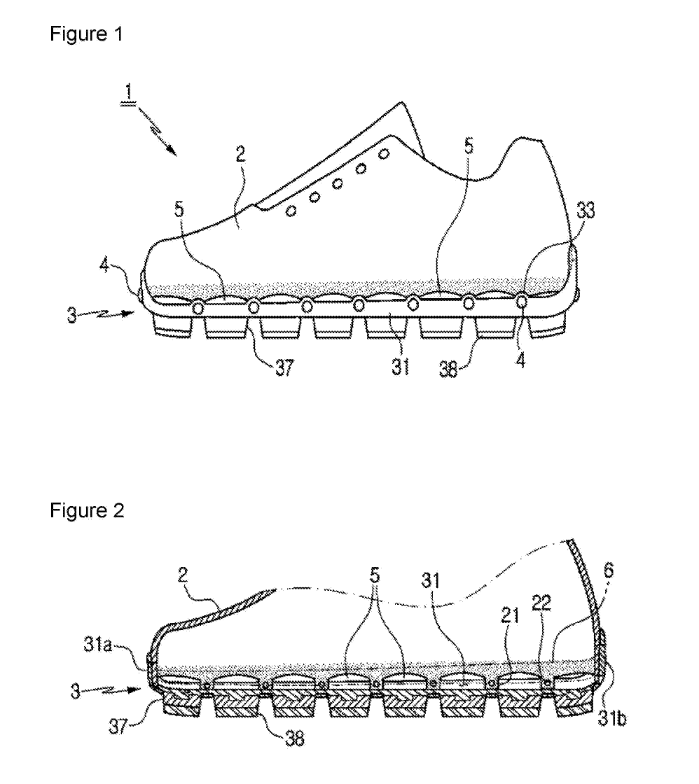

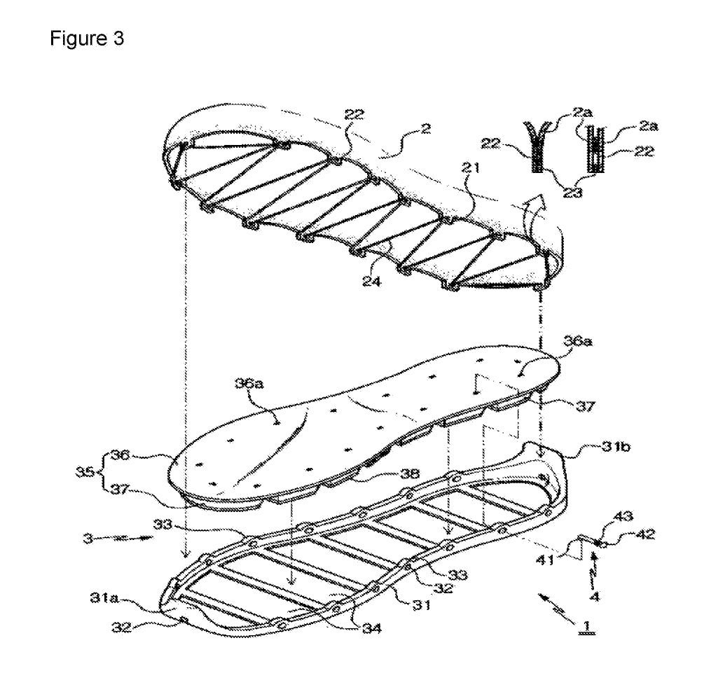

FIG. 1 is a front view illustrating a gluing-free shoe according to the present invention, FIG. 2 is a cross sectional view in FIG. 1, and FIG. 3 is a disassembled perspective view illustrating a gluing-free shoe according to the present invention.

The gluing-free shoe 1 according to the present invention may be applied to various types of shoes 1, for example, sneakers, outdoor shoes, etc. As illustrated in the drawings, the gluing-free shoe 1 may be manufactured in such a way that a sole 3 is firmly coupled to an upper leather 2 using a plurality of fixing pins 4 without using any bond.

Each component of the present invention will be described in detail below.

—The Upper Leather—

The upper leather 2 may include a plurality of upper leather fixing pieces 21 protruding downward along the lower ends of the upper leather 2, wherein a fixing hole 22 is formed passing through each upper leather fixing piece 21.

The upper leather 2 may be made of any of a natural leather, an artificial leather, a raw fabric, a non-woven fabric, etc.

A reinforcing core 23 is embedded at the lower ends of the upper leather 2 and inside of each upper leather fixing piece 21. The reinforcing core 23 may be preferably embedded in such a way that the reinforcing core 23 may be inserted into between two-layer upper leather members 2a which define the upper leather 2, and may be fixedly adhered thereto in place or a hot melt adhesive maybe inserted between the upper leather members 2a and may be melted and hardened by applying heat thereto.

The upper leather fixing pieces 21 maybe subjected to a lasting process.

As illustrated in FIG. 3, the lasting process may be carried out, for example, in such a way that the shape of the upper leather 2 is shaped by inserting a synthetic fiber thread having a predetermined durability is inserted into a fixing hole 22 formed at each upper leather fixing piece 21 and is pulled.

In the present invention, since the shape of the upper leather 2 can be maintained with the aid of the reinforcing core 23, the aforementioned lasting process may be omitted.

—The Sole—

The sole 3 may include a frame 31 fixed at the upper leather 2, and an outsole 35 inserted into the frame 31.

The frame 31 may be injection-molded using a hard synthetic resin or may be molded using a rubber and may include a plurality of frame fixing pieces 33 protruding upward along an upper end of the frame 31, wherein a pin engaging hole 32 is formed passing through each frame fixing pieces 33. The frame fixing pieces 33 are disposed outside of the upper leather fixing pieces 21 formed at the upper leather 2 when the frame fixing pieces 33 and the upper leather fixing pieces 21 are engaged. A plurality of outsole assembling holes 34 are formed at regular intervals passing through the surface of the frame 31.

Moreover, the outsole 35 may include an upper plate 36 which is made of a hard synthetic resin and is seated on the top of the frame 31, and a lug 37 which is foam-molded integral with the upper plate 36 so as to be inserted into the outsole assembling holes 34 formed passing through the frame 31 or may be constituted in a structure wherein the upper plate 36 and the lug 37 are constituted in an integrated and molded sole type using any of a synthetic resin, an EVA sponge, a PU and a rubber.

In case of the aforementioned lug 37, a pad 38 made of a rubber material having a good resistance to abrasion may be adhered to a portion contacting with the ground. The outsole assembling hole 34 and the lug 37 have the same shapes and may change into various shapes based on the design of the shoe 1.

—The Fixing Pin—

The fixing pin 4 may be injection-molded using a synthetic resin having a good durability and a high strength. A hook 41 may be provided at a front end of the fixing pin 4, and a head 42 having a diameter larger than that of the pin engaging hole 32 formed at the frame fixing piece 33 may be formed at a rear end thereof.

Moreover, a protrusion engaging part 43 may be formed in front of the head 42 and may be hooked by a fixing hole 22 formed at the upper leather fixing piece 21 and by the pin engaging hole 32 formed at the frame fixing piece 33.

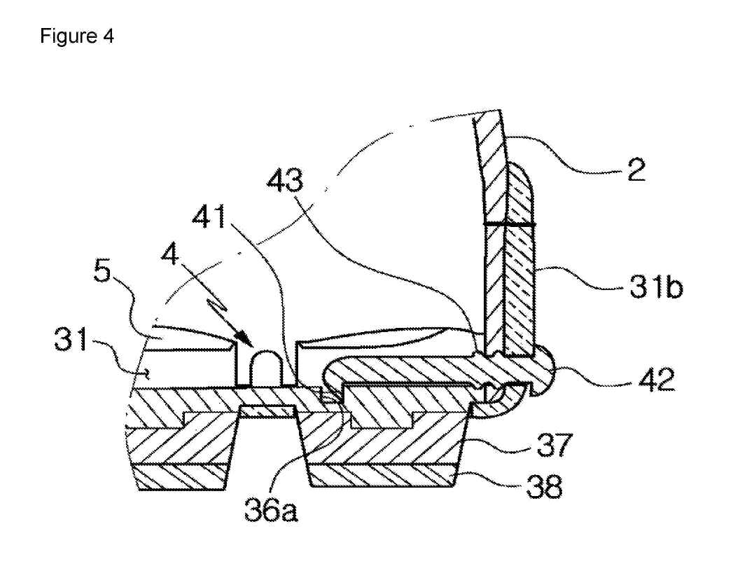

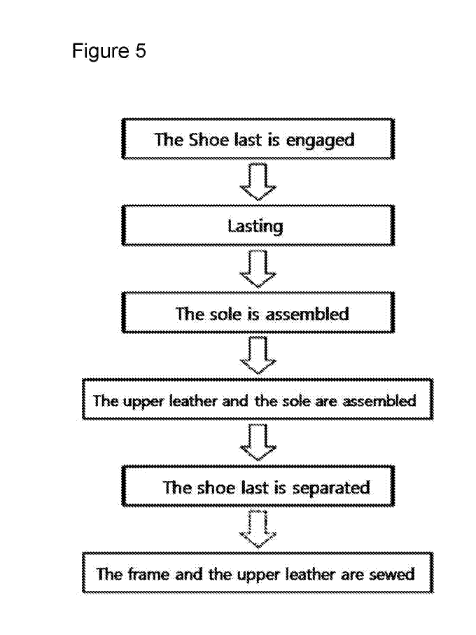

As illustrated in FIG. 2 or 4, the upper leather 2 and the sole 3 may be engaged using the fixing pin 4 which is inserted into the fixing hole 22 of the upper leather 2 via the pin engaging hole 32 formed at the frame fixing piece 33. In a state where the fixing pin 4 has been inserted, the hook 41 may be hooked by the engaging groove 36a formed at the upper plate 36 of the outsole, whereby the upper leather 2 and the sole 3 can be coupled without any bonding process. Moreover, a required durability of the fixing pin 4 can be obtained with the aid of the natural compressing since the inner space of the shoe 1 can be filled when a user wears the shoe 1.

When the upper leather 2 and the sole 3 are coupled, the air ventilation spaces 5 may be formed between the upper leather fixing pieces 21 formed at the lower ends of the upper leather 2. In the inside of the shoe 1, the air ventilation function and water drainage function can be carried out via the air ventilation spaces 5.

Meanwhile, the upper leather 2 and the sole 3 can be more completely coupled by a sewing method in such a way to fix the portions of the toe 31a of the frame 31 and of the heel 31b based on the functionality of the shoe 1.

Reference number 6 in the drawings represents a thick shoe insole 6 which inwardly underlies the upper leather 2 while overlying the top of the outsole 35. The shoe insole 6 may be made soft in such a way to foam an EVA, PU, PE, etc. In a state where the shoe insole 6 is engaged, a user may have a predetermined cushion feeling during the wearing of the shoe 1 since any irritation feeling which might occur due to the presence of the fixing pin 4 and the lasted synthetic fiber thread 24 can be eliminated.

An inner layer made of Goretex (Trademark) material may be further attached to the inner side of and the bottom of the upper leather 2.

The method for manufacturing a gluing-free shoe according to the present invention will be described.

FIG. 5 is a block diagram for describing the method for manufacturing a gluing-free shoe according to the present invention. The method for manufacturing a gluing-free shoe may include (1) a shoe last engaging step, (2) a lasting step, (3) a sole assembling step, (4) a step for assembling an upper leather and a sole, and (5) a shoe last separating step, which are carried out in the sequence which appears above.

According to another embodiment of the present invention, the method for manufacturing a gluing-free shoe may include (1) a shoe last engaging step, (2) a lasting step, (3) a sole assembling step, (4) a shoe last separating step, (5) a step for assembling an upper leather and a sole, and (6) a step for sewing a frame and an upper leather, which are carried out in the sequence which appears above.

(1) The Shoe Last Engaging Step

A plurality of the upper leather fixing pieces 21 are formed protruding downward from the lower ends of the upper leather 2, wherein the fixing hole 22 is formed passing through each upper leather fixing piece 21. The upper leather 2 wherein the reinforcing core 23 is embedded at the lower ends and the insides of the upper leather fixing pieces 21 is covered over the shoe last.

The reinforcing core 23 is adapted to provide a function to maintain the shape of the upper leather 2.

(2) The Lasting Step

In a state where the upper leather 2 is inserted into the shoe last, a lasting process will be carried out in such a way to insert the synthetic fiber thread 24 into the fixing hole 22 formed at the upper leather fixing piece 21.

The lasting process may be selectively carried out in the present invention. The lasting process is carried out to shape the upper leather 2.

(3) The Sole Assembling Step

The lug 37 of the outsole 35 is inserted into the outsole assembling hole 34 of the frame 31 which has been injection-molded using a synthetic resin or of the rubber frame 31 which has been molded using a rubber material.

Here, the outsole 35 may include an upper plate 36 which is made of a hard synthetic resin and is seated on the top of the frame 31, and a lug 37 which is foam-molded integral with the upper plate 36 so as to be inserted into the outsole assembling holes 34 formed passing through the frame 31 or may be constituted in a structure wherein the upper plate 36 and the lug 37 are constituted in an integrated and molded sole type using any of a synthetic resin, an EVA sponge, a PU and a rubber.

The aforementioned configuration is able to enhance a wearing feeling of the shoe 1 since the lug 37 is providing an enough cushioning effect while enhancing the durability of the sole 3.

(4) The Step for Assembling the Upper Leather and the Sole

The frame 31 is inserted beneath the upper leather 2. Here, the frame fixing pieces 33 disposed above the frame 21 will position outside the upper leather fixing pieces 21 formed at the lower ends of the upper leather 2. In this state, the fixing pin 4 is inserted into the fixing hole 22 of the upper leather 2 via the pin engaging hole 32 formed at each frame fixing piece 33.

The hook 41 formed at the front end of the thusly inserted fixing pin 4 may be hooked by the engaging groove 36a formed at the upper plate 36 of the outsole 35, and the protrusion engaging part 43 formed at the head 42 of the fixing pin 4 may be hooked by the fixing hole 22 formed at each upper leather fixing piece 21 and by the pin engaging hole 32 formed at each frame fixing piece 33, thus obtaining a firmly fixed state.

(5) The Shoe Last Separating Step

If the upper leather 2 and the sole 3 has been fixed with the fixing pins 4, the shoe last will be separated from the upper leather 2, and the coupled states of the fixing pins 4 are checked, and the insole 6 is inwardly inserted beneath the upper leather 2.

(6) The Step for Sewing the Frame and the Upper Leather

After the step for separating the upper leather 2 from the shoe last has been carried out, the portions of the toe 31a and of the heel 31b of the frame 31 are fixed with the upper leather 2 by a sewing method based on the functionality of the shoe 1, whereby the upper leather 2 and the sole 3 can be more completely coupled. While it has been described that the coupling method is carried out by a sewing method, this coupling method may be carried out using a predetermined adhesive.

If the shoe 1 is manufactured based on the gluing-free shoe 1 and the method for manufacturing the same according to the present invention, the work condition can be improved, and the productivity can be enhanced, and the number of the workers at the manufacturing line can be reduced, and the defect ratio can be reduced.

The invention has been described in detail with reference to preferred embodiments thereof. However, it will be appreciated by those skilled in the art that changes maybe made in these embodiments without departing from the principles and spirit of the invention, the scope of which is defined in the appended claims and their equivalents.

### LEGENDS OF REFERENCE NUMBERS

1: (Gluing-free) shoe 2: Upper leather
2a: Upper leather member 21: Upper leather fixing pieces
22: Fixing hole 23: Reinforcing core
24: Synthetic fiber thread 3: Sole
31: Frame 31a: Toe
31b: Heel 32: Pin engaging hole
33: Frame fixing piece 34: Outsole assembling hole
35: Outsole 36: Upper plate
36a: Engaging groove 37: Lug
38: Pad 4: Fixing pin
41: Hook 42: Head
43: Protrusion engaging part

What is claimed is:

1. A gluing-free shoe, comprising:
an upper leather; and
a sole, wherein the upper leather and the sole are coupled by a plurality of frame fixing pieces of the sole and a plurality of fixing pins which are inserted into a plurality of pin engaging holes and a plurality of fixing holes formed at the upper leather, thus coupling the upper leather and the sole without using any adhesive, wherein the upper leather includes a plurality of upper leather fixing pieces which are formed protruding from the lower ends of the upper leather, with a fixing hole formed passing through each upper leather fixing piece, and a reinforcing core with a high strength and durability is embedded at the lower ends of the upper leather and inside the upper leather fixing pieces, and the sole includes a frame fixed at the upper leather, and an outsole inserted into the frame, and the frame is injection-molded using a synthetic resin or is made of a rubber mold material formed using a rubber material, and the sole includes a plurality of frame fixing pieces which are formed upward at the edges thereof, and a pin engaging hole is formed at each frame fixing piece, and the frame fixing pieces are disposed outside the upper leather fixing pieces formed at the upper leather, and the outsole includes an upper plate which is seated on the top of the frame and is made of a hard synthetic resin, and a foam-molded lug which is integral with the upper plate so as to be inserted into an outsole assembling hole while passing through the frame from top to bottom or the outsole is provided in an integrally molded sole structure wherein the upper plate and the lug are integrated using any of a synthetic resin, an EVA sponge, a PU and a tuber, and a head formed larger than the pin engaging hole is formed at a rear end of the fixing pin, and a hook is formed at a front end, wherein the hook is hooked by an engaging groove formed at the upper plate of the outsole.

2. The shoe of claim 1, wherein the fixing pin include a protrusion engaging part formed in front of a head and is configured to be hooked by a fixing hole formed at each upper leather fixing piece and a pin engaging hole formed at each frame fixing piece.

3. The shoe of claim 1, wherein the upper leather is coupled with the portions of the toe and of the heel of the frame by a sewing method.

4. A method for manufacturing a gluing-free shoe which is formed of an upper leather; and a sole, wherein the upper leather and the sole are coupled by a plurality of frame fixing pieces of the sole and a plurality of fixing pins which are inserted into a plurality of pin engaging holes and a plurality of fixing holes formed at the upper leather, thus coupling the upper leather and the sole without using any adhesive, comprising:
a step wherein an upper leather is covered over a shoe last;
a step wherein a rug is inserted into an outsole assembling hole of a frame which is injection-molded with a synthetic resin or is made of a rubber material molded with a rubber material, wherein the rug is formed at any of an outsole including an upper plate which is made of a hard synthetic resin and is seated on the top of the frame, and a lug which is foam-molded integral with the upper plate so as to be inserted into the outsole assembling holes formed passing through the frame or an outsole which is constituted in a structure wherein the upper plate and the lug are constituted in an integrated and molded sole type using any of a synthetic resin, an EVA sponge, a PU and a rubber;
a step wherein in a state where the frame fixing pieces formed at the top of the frame are disposed outside the upper leather fixing pieces formed at the lower ends of the upper leather, the fixing pin is coupled in such a way that the hook at the front end thereof is hooked by the engaging groove formed at the upper plate of the outsole in a state where the fixing pin has been inserted in the fixing hole of the upper leather via a pin engaging hole formed at each frame fixing piece; and
a step wherein the upper leather is separated from the shoe last, wherein the aforementioned steps are carried out in the sequence where they appear.

5. The method of claim 4, further comprising:
a step wherein the portions of the toe and of the heel of the frame are fixed by a sewing method based on the functionality of the shoe after the upper leather has been separated from the shoe last.
